(19) United States
(12) Patent Application Publication
(10) Pub. No.: US 2026/0095403 A1
(43) Pub. Date: Apr. 2, 2026

(54) TRAFFIC REROUTING IN A LINK AGGREGATION GROUP

(71) Applicant: Hewlett Packard Enterprise Development LP, Spring, TX (US)

(72) Inventors: Jonathan P. Beecroft, Bristol (GB); Duncan Roweth, Bristol (GB); Abdulla M. Bataineh, Vista, CA (US); David Charles Hewson, Bristol (GB); Anthony M. Ford, Bristol (GB); Eric R. Borch, Fort Collins, CO (US)

(21) Appl. No.: 18/899,979

(22) Filed: Sep. 27, 2024

(51) Int. Cl. H04L 45/24; H04L 45/00; H04L 47/283

(52) U.S. Cl. CPC H04L 45/245; H04L 45/22; H04L 47/283

(57) ABSTRACT

A system receives, by a network device in a first network fabric, a to be forwarded flow over a link aggregation group (LAG) comprising a plurality of physical ports aggregated as a single logical port. The system determines loads associated with the LAG ports and selects a first LAG port based on a first load associated with the first LAG port. The system forwards the flow on a first path over the selected first LAG port. The system stores a state of the flow, wherein the flow is forwarded in a second network fabric. The system receives, from the first LAG port, a redirect acknowledgment (ACK) indicating that the flow is to be considered as a candidate flow to be rerouted. The system selects the flow from a plurality of candidate flows to be rerouted and forwards the selected flow on a second path over a second LAG port.

### STATEMENT OF GOVERNMENT-FUNDED RESEARCH

This application was made with Government support under Contract number H98230-15-D-0022/0003 awarded by the Maryland Procurement Office. The Government has certain rights in this invention.

### BACKGROUND

Ethernet networks can be inter-connected by a link aggregation group (LAG), which can include a plurality of physical ports aggregated as a single logical port. Traffic can be distributed over physical links in the LAG based on a hash on the packet header, which can preserve the order of packets in a flow. However, using a hash may result in poor distribution of traffic, e.g., given two active flows using a two-port LAG, a high likelihood exists of both flows being assigned to one physical link while the other physical link remains idle.

### BRIEF DESCRIPTION OF THE FIGURES

FIG. 1A illustrates an environment which facilitates traffic rerouting in a LAG, in accordance with an aspect of the present application.

FIG. 1B illustrates configurations of networks which facilitate traffic rerouting in a LAG, in accordance with an aspect of the present application.

FIG. 2A illustrates an environment which facilitates traffic rerouting in a LAG between a first network fabric and a second network fabric, including selecting a LAG port based on load, in accordance with an aspect of the present application.

FIG. 2B illustrates an environment which facilitates traffic rerouting in a LAG, including congestion acknowledgments (ACKs) from a second network fabric which throttle traffic at an ingress port in a first network fabric, in accordance with an aspect of the present application.

FIG. 2C illustrates an environment which facilitates handling congestion ACKs from LAG ports in a first network fabric which throttle traffic at an ingress port in the first network fabric, in accordance with an aspect of the present application.

FIG. 2D illustrates an environment which facilitates traffic rerouting in a LAG, including redirect ACKs from LAG ports in a first network fabric which prompt an ingress port in the first network fabric to reroute a flow, in accordance with an aspect of the present application.

FIG. 3A presents a flowchart illustrating a method which facilitates traffic rerouting in a LAG, in accordance with an aspect of the present application.

FIG. 3B presents a flowchart illustrating a method which facilitates traffic rerouting in a LAG, including a network device operating as an ingress node, in accordance with an aspect of the present application.

FIG. 4 illustrates a computer system which facilitates traffic rerouting in a LAG, in accordance with an aspect of the present application.

FIG. 5 illustrates a computer-readable medium which facilitates traffic rerouting in a LAG, in accordance with an aspect of the present application.

In the figures, like reference numerals refer to the same figure elements.

### DETAILED DESCRIPTION

Aspects of the present application provide a system which facilitates traffic rerouting in a link aggregation group (LAG), based on redirect ACKs sent by a LAG port in a local fabric and congestion ACKs sent by an egress network device in a remote fabric.

Networks, such as Ethernet networks, can be inter-connected by a LAG. A LAG can include a plurality of physical ports aggregated as a single port. A LAG can connect networks (or network fabrics), and the LAG ports of a network may be on the same switch or distributed across multiple switches. Traffic may be forwarded from an ingress port of a first network, through the first network, and exit the first network via an egress port, e.g., one of the LAG ports. The traffic may then be forwarded from the egress LAG port to an ingress LAG port of a second network, through the second network and may exit the second network via another egress port.

Traffic can be distributed over physical links in the LAG based on a hash on the packet header, which can preserve the order of packets in a flow. In one case, using a hash of the packet header on a large number of flows all with similar bandwidth may average out over a certain number of links. However, in another case, a small number of flows with high bandwidths may result in a poor distribution of traffic. For example, given two active flows using a two-port LAG, a high likelihood exists of both flows being assigned to one physical link while the other physical link remains idle. In yet another case, an imbalance in packet size may result in latency issues, e.g., many small messages or “mice” flows queued up behind a few jumbo frames or “elephant” flows.” These cases may result in sub-optimal forwarding functionality and inefficient traffic flow when relying on a hash to select LAG ports between networks.

Over-provisioning LAGs may be a common industry practice to address the inefficiencies of a hash-based distribution function. However, over-provisioning can increase the cost, which can further increase with increased speeds. Over-provisioning may also result in a high percentage of unused available bandwidth and resources, which can further result in an inefficient overall system. Furthermore, while over-provisioning may result in a lower likelihood that multiple flows may be assigned to the same physical link, over-provisioning cannot entirely eliminate the problem.

The described aspects address these inefficiencies by providing a system which preserves the order of flows, accounts for the failure of individual LAG ports, and allows for dynamic rebalancing of the flows as the load continues to change. Data may be transmitted or forwarded between LAG ports of a first network fabric to LAG ports of a second network fabric. For example, data may travel from an ingress port of the first network fabric, through one or more intermediate network devices of the first network fabric, to an egress LAG port (“local egress LAG port”) of the first network fabric. The data may continue across an “extended” network and be forwarded to an ingress LAG port of the second network fabric, through one or more intermediate network devices of the second network fabric, to an egress port (e.g., “remote egress port”) of the second network fabric. An “extended” network may include two network fabrics which operate using the same protocol (e.g., a standard protocol or a proprietary protocol).

For a given flow, the system can select a LAG port (i.e., a local ingress LAG port of the plurality of LAG ports of a LAG) in the first network fabric (over which to forward the flow) based on the load for each LAG port. The load associated with a LAG port may be communicated to network devices in a network fabric based on control information distributed between the network devices. This information may be accumulated in a hierarchical manner to increase efficiency. In hierarchical networks (e.g., dragonfly and fat-tree networks), switches in a network fabric may be organized into groups. Traffic may travel from a source group to a destination group, by entering the network fabric at an ingress port and exiting the network fabric at an egress port. Traffic can be forwarded from the ingress port (in the source group) towards the destination group and from there to the destination switch and the egress port. Information on LAG usage may be distributed both amongst switches in a group and between groups.

A trade-off may exist between precision (e.g., the amount of data distributed between the network devices) and bandwidth (e.g., the amount of bandwidth consumed in order to distribute that data). The measurement or quantification of the LAG load may be a metric which can be tuned, by balancing precision and bandwidth. One categorization of the load can be a value in a plurality of ranges of values, where a respective range indicates a level of usage of the respective LAG port. For example, using four ranges of values, each range can include a certain level of usage of a LAG port: a first range of values may indicate that the respective LAG port is idle; a second range of values may indicate that the respective LAG port is lightly loaded; a third range of values may indicate that the respective LAG port is moderately loaded; and a fourth range of values may indicate that the respective LAG port is heavily loaded. The thresholds for defining “idle,” “lightly loaded,” “moderately loaded,” and “heavily loaded” as well as the ranges of values may be preconfigured or set by the system as a default or by an administrative user associated with the system. While four ranges of values are described above, this is an illustrative example only. Other categories, numbers, and values of ranges may be used. In addition, other methods may be used to determine the ranges of values, e.g., the system may learn the ranges based on operation of the system or other factors.

The system can also select the LAG port based on other factors or metrics, including but not limited to, e.g.: a cost of reaching a respective LAG port; a group associated with the respective LAG port; a type of the flow; a Quality of Service (QoS) associated with the flow; and a state of the flow. In some aspects, in order to avoid “flocking” (in which the same path may be selected for multiple inputs), the system can use a mix of a load metric and a hash or other randomized method. For example, the system may identify a set of LAG ports associated with loads less than a predetermined threshold (“first predetermined threshold”), and the system may select a LAG port from this identified set based on a hash on one or more fields of a header of a packet in the flow or based on a random number generator. By using a mix of the load metric and a hash or randomization, the described aspects may avoid flocking, which can result in a more efficient overall system. Furthermore, the system can dynamically (e.g., in real-time) determine the loads associated with LAG ports, including the system determining loads as reported by and between the network devices. The system can respond to these dynamic changes in the load in a gradual manner, which may also help to avoid flocking and consequently result in a more efficient overall system.

If the LAG connects the first network fabric to a second network fabric and both network fabrics use a common interface or protocol (e.g., a standard protocol), the system can track the flow as it extends from the first network fabric to the second network fabric (e.g., using a flow control mechanism). By tracking the flow, the system can implement specific policies on when to reroute a flow or throttle (e.g., slow down or pause) a flow.

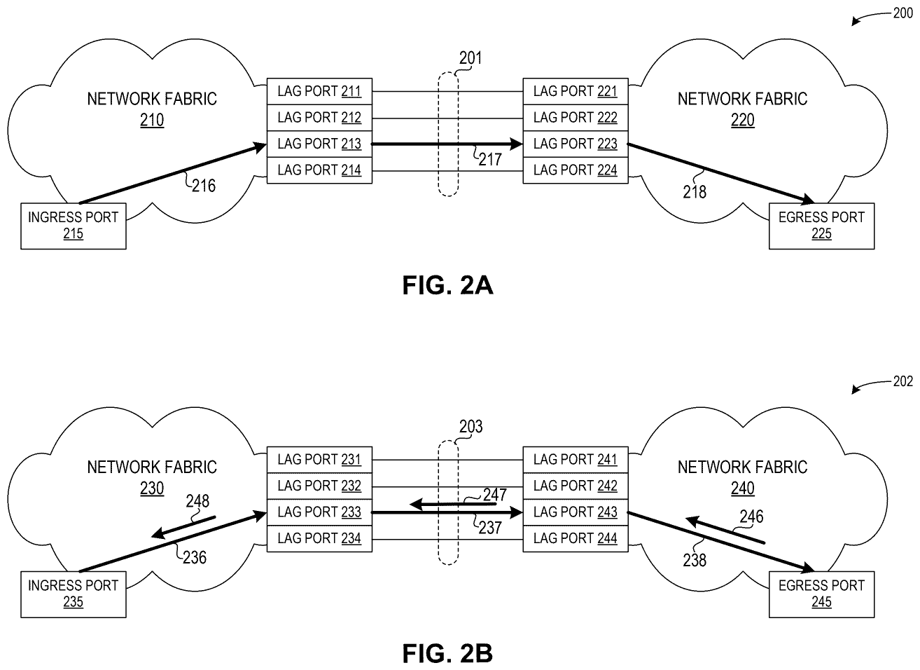

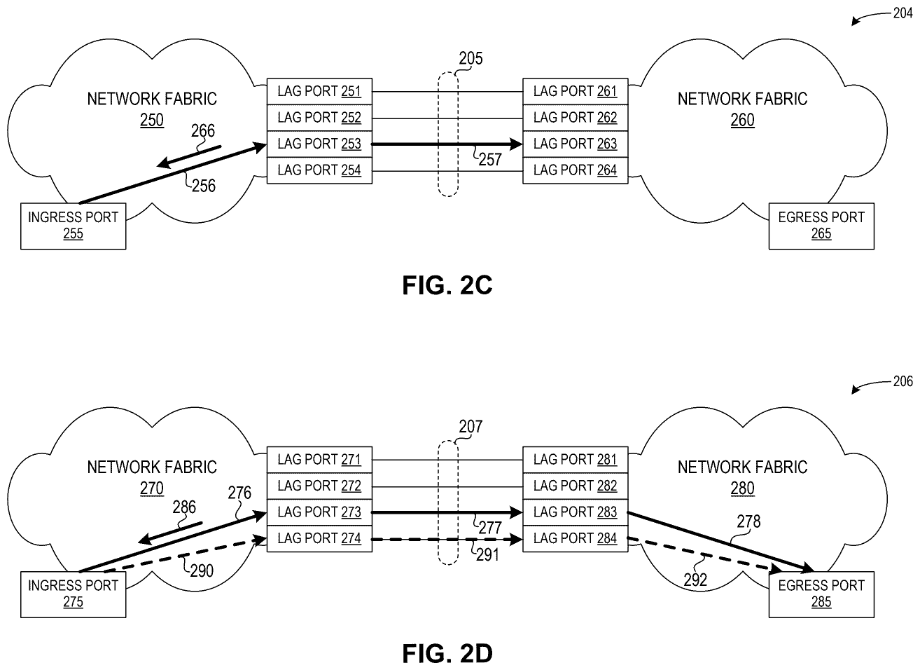

For example, if a flow forwarded over a LAG port experiences endpoint congestion at a remote egress port of the second network fabric, the system can throttle the flow based on a congestion ACK sent from the remote egress port of the second network fabric to an ingress port of the first network fabric, as described below in relation to FIG. 2B. Similarly, if a flow forwarded over a LAG port experiences congestion at an egress LAG port of the first network fabric, the system can throttle the flow based on a congestion ACK sent from the egress LAG port to an ingress port of the first network fabric, as described below in relation to FIG. 2C.

As another example, if a flow forwarded over a LAG port experiences “mid-fabric” congestion (e.g., at the egress LAG port in the first network fabric in a flow which extends across two network fabrics), the system can reroute the flow based on a redirect ACK sent from the egress LAG port in the first network fabric to an ingress port of the first network fabric, as described below in relation to FIG. 2D. Furthermore, if the LAG itself is overcommitted (i.e., the total load on the LAG exceeds a threshold), the system can throttle the flows using the LAG based on a congestion ACK sent from the LAG ports.

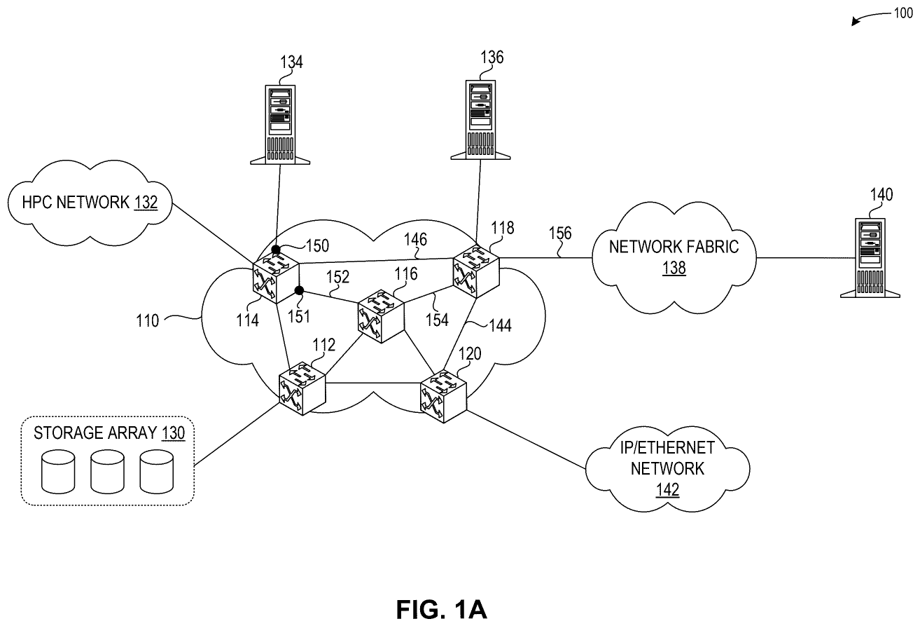

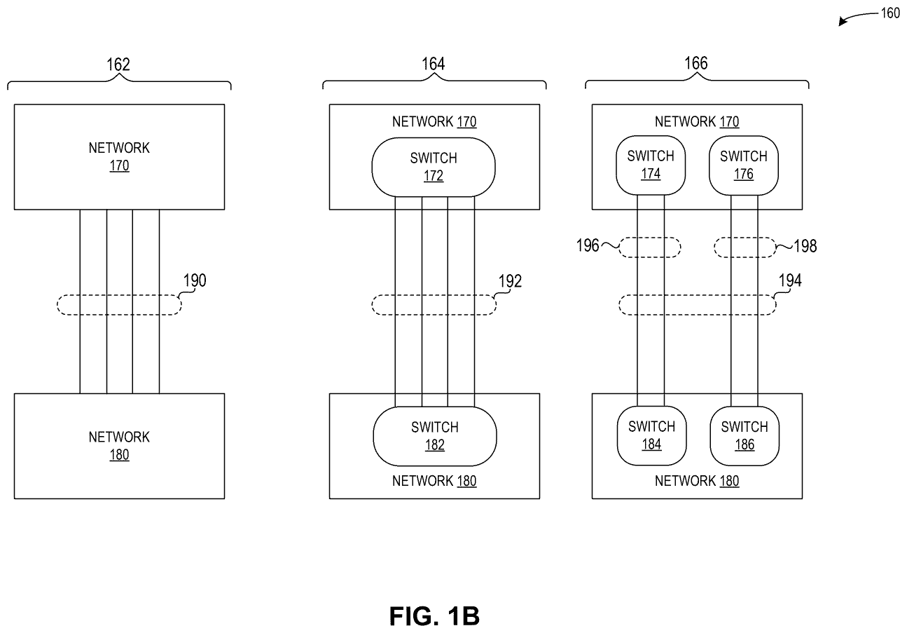

Thus, the described aspects provide a system which, by selecting between paths in a LAG based on load, can efficiently distribute traffic over the LAG ports, maintain order while a flow is active, and provide a high and tunable probability of maintaining order as a flow is retired. The system can dynamically adjust its selection of LAG ports for flows based on various circumstances and conditions, as described herein. This load-based distribution can result in a more efficient and flexible overall system. The described aspects can apply to both single switch and multi-chassis LAGs and can also support networks with multiple and wide LAGs, as described below in relation to FIGS. 1A and 1B.

Furthermore, the described aspects can perform congestion management by throttling traffic based on congestion ACKs from local LAG ports (of a first network fabric) or remote egress ports (of a second network fabric) and can reroute traffic in a LAG based on redirect ACKs from local egress LAG ports given traffic flowing from the first network fabric to the second network fabric. The described aspects can provide a flow control mechanism that may be used to improve communications between and performance of interconnected systems and networks, e.g., a supercomputer, artificial intelligence training factory, or analytics platform connected to a high-performance storage server with each system using an independently managed fabric.

FIG. 1A illustrates an environment 100 which facilitates traffic rerouting in a LAG, in accordance with an aspect of the present application. Environment 100 can include a network 110 of network devices (such as switches) and can be referred to as a “switch fabric” or a “network fabric.” Network fabric 110 can include switches 112, 114, 116, 118, and 120. Each switch can have a unique address or identifier within switch fabric 110. Various types of endpoints, processing nodes, devices, and networks can be coupled to a switch or network fabric. For example, a storage array 130 may be coupled to switch fabric 110 via switch 112; a high performance computing (HPC) network (e.g., InfiniBand, Slingshot, or any other high performance network) 132 may be coupled to switch fabric 110 via switch 114; a number of end hosts, such as devices 134 and 136, may be coupled to switch fabric 110 via, respectively, switches 114 and 118; another network fabric 138 may be coupled to switch fabric 110 via switch 118; and an Internet Protocol (IP)/Ethernet network 142 may be coupled to switch fabric 110 via switch 120.

HPC network 132 may include multiple networked computer and storage devices concurrently running programs to complete different complex and performance-intensive tasks. IP/Ethernet network 142 may include physical Ethernet cabling and an application layer protocol between network devices based on IP, including communication via Transport Communication Protocol (TCP)/IP and User Datagram Protocol (UDP) packets. Network fabric 138 may include a plurality of interconnected network devices or nodes (not shown), including ingress network devices, intermediate network devices, and egress network devices. Network fabric 138 may be coupled to one or more end hosts or endpoint nodes (e.g., a device 140). Network fabrics 110 and 138 may communicate via a LAG 156, as described below in relation to networks 170 and 180 of FIG. 1B.

In general, a switch can have edge ports and fabric ports. An edge port (such as 150) can couple to a device that is external to the fabric. An edge port can operate as an ingress port (when receiving data from the external device) or as an egress port (when transmitting data to the external device). A fabric port (such as 151) can couple to another switch within the fabric via a fabric link. A fabric port can also operate as an ingress port (when receiving data from another switch in the fabric via a fabric link) or as an egress port (when transmitting data to another switch in the fabric via a fabric link). Typically, traffic may be injected into switch fabric 110 via an ingress edge port of a switch and may leave switch fabric 110 via an egress edge port of another (or the same) switch. An ingress link can couple a network interface controller (NIC) of an edge device (e.g., an HPC end host) to an ingress edge port of a switch in the network fabric. Switch fabric 110 can then transport the traffic to an egress edge port, which in turn can deliver the traffic to a destination edge device via another NIC. A packet can be forwarded in switch fabric 110 based on its Layer-2 address (“fabric address”). In an Ethernet-based switch fabric, the Layer-2 address may be an Ethernet media access control (MAC) address. The forwarding path for the packet may be determined based on adaptive forwarding, e.g., based on local programming of the switches in switch fabric 110 and information related to load, traffic, and congestion available to and associated with switch fabric 110.

In some aspects, switch fabric 110 and network fabric 138 may include network devices (i.e., switches) including ingress network devices, intermediate or mid-point network devices, and egress or endpoint network devices. A switch in switch fabric 110 may include systems which perform operations associated with an ingress network device, an intermediate network device, and an egress network device. For example, switch 118 may be an ingress network device for data originating from device 136 and destined for IP/Ethernet network 142 (with switch 120 as the egress network device for such data), and switch 118 may also be an egress network device for data originating from IP/Ethernet network 142 and destined for device 136 (with switch 120 as the ingress network device for such data). In addition, a switch in switch fabric 110 may include systems which perform operations associated with mid-point network devices. For example, switch 118 may be an intermediate network device for data originating from IP/Ethernet 142 and destined for HPC network 132, e.g., via a possible path which includes switch 120 (acting as an ingress network device), via a communication 144 to switch 118 (acting as an intermediate network device), and via a communication 146 to switch 114 (acting as an egress network device). Thus, a single switch may include systems which perform functionality relating to an ingress network device, an intermediate network device, and an egress network device.

FIG. 1B illustrates diagrams 162, 164, and 166 of networks which facilitate traffic rerouting in a LAG, in accordance with an aspect of the present application. In diagram 162, a network 170 is depicted as connected to, coupled to, capable of communication with, or in communication with a network 180 via a LAG 190, which includes a plurality of physical links aggregated as a single logical link. The ports or links of the LAG (referred to as LAG ports) may be on a same switch or distributed over multiple switches.

For example, diagram 164 depicts that all four LAG links of LAG 192 are on a single switch 172 of network 170 and on a single switch 182 of network 180. As another example, diagram 166 depicts that the four LAG links of LAG 194 are distributed across two switches in each network. That is, two (196) of the four LAG links of LAG 194 are on a switch 174 of network 170 and on a switch 184 of network 180, while another two (198) of the four LAG links of LAG 194 are on a switch 176 of network 170 and on a switch 186 of network 180. Switch 172 of network 170 may correspond to switch 118 of network fabric 110 in FIG. 1A, and switch 182 of network 180 may correspond to a switch (not shown) coupled to switch 118 over LAG 156 in network fabric 138 in FIG. 1A. The described system and operations may be applied to single switch and multi-chassis LAGs (as in FIG. 1B). In addition, the described system may support networks with multiple or wide LAGs, as described below in relation to LAGs 201, 203, 205, and 207 of, respectively, FIGS. 2A-D.

As another example in FIG. 1A, data traveling from end host 134 and destined for end host 140 may travel through both switch fabric 110 and network fabric 138. Data can enter switch fabric 110 at an ingress edge port (150) of ingress switch 114 and may travel via a possible path which includes intermediate switch 116 (via a communication 152) and egress switch 118 (via a communication 154). Switch 118 may be coupled to network fabric 138 via LAG 156, which can include a plurality of LAG ports (as described above in relation to FIG. 1B).

The data may continue traveling to destination device 140 via an ingress network device, intermediate network devices, and an egress network device (not shown) of network fabric 138. Switch 114, operating as the ingress network device in this example, may select a particular LAG port (of LAG 156) over which the flow is to be forwarded to network fabric 138. Switch 114 can select the particular LAG port by determining the loads associated with the LAG ports of LAG 156, e.g., based on control information distributed and exchanged between the network devices in network fabric 110. Furthermore, switch 114 can select the particular LAG port or determine to send or move a flow to a particular LAG port under certain circumstances, including: at any time for unordered traffic; upon ingress when the flow has no data in flight, thus preserving order; as an estimate or speculation with a low amount of risk of reordering traffic; and in a conservative manner (i.e., pausing for a predetermined period of time), thus allowing packets to traverse a remote network and increasing the probability of maintaining order. Thus, the described aspects provide a flow control mechanism which can extend the lifetime of a flow at ingress (e.g., by selecting a particular LAG port for a flow or based on a speculation or a conservative technique), which can result in delaying the point at which a flow is retired.

During operation, switch 118 may monitor the load on its LAG ports. If switch 118 detects certain conditions relating to the monitored load (or other metrics), switch 118 may send, upstream to ingress node 114, a redirect ACK indicating that the flow for a given LAG port is to be considered as a candidate flow to be rerouted. Receiving a redirect ACK from a LAG port based on certain conditions is described below in relation to FIG. 2D.

In addition, the system (including ingress switch 114 and egress switch 118 of the above example) can dynamically adjust the usage of the LAG ports. For example, if the load on the LAG ports becomes unbalanced or uneven, if the load on a particular LAG port exceeds one or more predetermined thresholds (“third predetermined threshold”), if the total load on the LAG ports exceeds one or more predetermined thresholds (“fourth predetermined threshold”), or if a change in the loads on the LAG ports exceeds one or more predetermined thresholds (“fifth predetermined threshold”), the system can move a particular flow to a different LAG port. The system can maintain an order of the packets in the particular flow while forwarding the particular flow on a second path.

In addition, switch 118 may store a state of the flow forwarded over the given LAG port and determine congestion based on the stored flow and other monitored conditions. As a result, switch 118 may send, upstream to ingress node 114, a first congestion ACK indicating a first value of congestion (e.g., as an explicit congestion avoidance (ECA) value) for the flow at the given LAG port. Receiving a congestion ACK from a LAG port is described below in relation to FIG. 2C.

Furthermore, a remote egress network device in network fabric 138 may determine congestion and send, upstream to ingress node 114, a second congestion ACK indicating a second value of congestion (e.g., as an ECA value) for the flow which travels through the given LAG port. Receiving a congestion ACK from a remote egress network device is described below in relation to FIG. 2B. The stored state can include the first congestion ACK and the second congestion ACK, including the first congestion value and the second congestion value. The system can throttle a flow based on receiving either the first congestion ACK or the second congestion ACK. However, in some cases, both the first congestion ACK and the second congestion ACK may be sent upstream, each including an ECA value. If the first ECA value indicates mild congestion while the second ECA value indicates severe congestion, depending on the order in which the congestion ACKs are received, the ingress node may end up under-throttling the flow.

To address this limitation, switch 118 can perform a comparison of the first value and the second value (both of which are stored as part of the state of the flow) and may send upstream the congestion ACK with the greater value. As a result, the ingress node (i.e., switch 114) may throttle the flow based on the respective congestion ACK indicating the greater value. Differentiating between congestions ACKs received for a similar flow is described below in relation to FIGS. 2B and 2C.

FIG. 2A illustrates an environment 200 which facilitates traffic rerouting in a LAG between a first network fabric 210 and a second network fabric 220, including selecting a LAG port based on load, in accordance with an aspect of the present application. For the sake of illustration, only certain ports are depicted in FIGS. 2A-D. The network devices associated with the depicted ports, as well as other network devices in the network fabric (such as ingress network devices, intermediate network devices, and egress network devices) are not depicted in FIGS. 2A-D. Furthermore, network devices in the network fabrics depicted in FIGS. 2A-D may distribute information to and exchange information with each other regarding their usage, bandwidth consumption, buffer depths, congestion information, and other load metrics. These network devices may use the distributed and exchanged information to determine, e.g., loads associated with a specific physical port. While only four ports or links of a single LAG are depicted on each of LAGs 201, 203, 205, and 207 of, respectively, FIGS. 2A-D, any number of LAGs or links may be used between network fabrics. For example, the LAG links may be distributed over multiple switches in each fabric or over switches in multiple groups in each fabric.

In FIG. 2A, network fabrics 210 and 220 may be coupled via a LAG 201, including LAG ports 211-214 on network fabric 210 and LAG ports 221-224 on network fabric 220. An ingress port 215 of network fabric 210 may receive data (i.e., a flow) from a source device (not shown) to be forwarded over LAG 201 to a destination device (not shown) via an egress port 225 of network fabric 220. Based on information exchanged within network fabric 210, the network device associated with ingress port 215 may determine loads associated with usage of the LAG ports and paths in network fabric 210 from the ingress port to the LAG ports. A load associated with a LAG port may be a value in a plurality of ranges of values, and a range may indicate a level of usage of the LAG port. For example, using four ranges of values: a first range may indicate that the respective LAG port is idle; a second range may indicate that the respective LAG port is lightly loaded; a third range may indicate that the respective LAG port is moderately loaded; and a fourth range may indicate that the respective LAG port is heavily loaded. The thresholds for defining “idle,” “lightly loaded,” “moderately loaded,” and “heavily loaded” as well as the ranges of values may be preconfigured or set by the system as a default or by an administrative user associated with the system. The use of four ranges of values is provided as an example only. Other values and ranges of values may be used.

Subsequent to determining the loads associated with LAG ports 211-214, the network device associated with ingress port 215 can select a first LAG port of LAG ports 211-214 for the flow based on the determined loads, i.e., based on a first load associated with the selected first LAG port. For example, the selected port may be LAG port 213, and ingress port 215 may forward the flow over a path 216 (which, as described above, may include other intermediate network devices) to LAG port 213. LAG port 213 can forward the data over a link or path 217 to LAG port 223 of network fabric 220, and LAG port 223 may forward the data over a path 218 to the destination device (not shown) via an egress port 225. The bold lines depicted by paths 216, 217, and 218 indicate the flow from the source to the destination device, including from ingress port 215 in network fabric 210 to egress port 225 in network fabric 220. Thus, FIG. 2A depicts selecting LAG port 213 based on the determined loads of LAG ports 211-214.

FIG. 2B illustrates an environment 202 which facilitates traffic rerouting in a LAG, including congestion acknowledgments (ACKs) from a second network fabric 240 which throttle traffic at an ingress port in a first network fabric 230, in accordance with an aspect of the present application. Network fabrics 230 and 240 may be coupled via a LAG 203, including LAG ports 231-234 on network fabric 230 and LAG ports 241-244 on network fabric 240. An ingress port 235 of network fabric 230 may receive data (i.e., a flow) from a source device (not shown) to be forwarded over LAG 203 to a destination device (not shown) via an egress port 245 of network fabric 240. Based on information exchanged within network fabric 230, the network device associated with ingress port 235 may determine loads associated with usage of the LAG ports and paths in network fabric 230 from the ingress port to the LAG ports (as described above in relation to FIG. 2A).

Subsequent to determining the loads associated with LAG ports 231-234, the network device associated with ingress port 235 can select a first LAG port of LAG ports 231-234 for the flow based on the determined loads, i.e., based on a first load associated with the selected first LAG port. For example, the selected port may be LAG port 233, and ingress port 235 may forward the flow over a path 236 (which, as described above, may include other intermediate network devices) to LAG port 233. LAG port 233 can forward the data over a link or path 237 to LAG port 243 of network fabric 240, and LAG port 243 may forward the data over a path 238 to the destination device (not shown) via egress port 245. The bold lines depicted by paths 236, 237, and 238 indicate the flow from the source to the destination device, including from ingress port 235 in network fabric 230 to egress port 245 in network fabric 240.

Egress port 245 may be associated with a remote egress or network device of network fabric 240. The remote network device may determine, based on information such as the depth of its output buffer queue or a rate of change in its output buffer queue, that congestion exists for the flow corresponding to paths 236-238. As a result, the remote network device may generate and send a congestion ACK (via a communication 246) upstream to ingress port 235, as depicted by communications 247 and 248. The congestion ACK may include an ECA value which indicates a level of congestion as measured and reported by the remote network device in network fabric 240. The network device associated with ingress port 235 can slow down or throttle the flow based on the congestion ACK (received via communication 248). Thus, FIG. 2B depicts throttling a flow based on a congestion ACK received from a remote network device over LAG port 233 which is selected based on the determined loads of LAG ports 211-214.

FIG. 2C illustrates an environment 204 which facilitates handling congestion ACKs from LAG ports in a first network fabric 250 which throttle traffic at an ingress port in the first network fabric 250, in accordance with an aspect of the present application. Network fabrics 250 and 260 may be coupled via a LAG 205, including LAG ports 251-254 on network fabric 250 and LAG ports 261-264 on network fabric 260. An ingress port 255 of network fabric 250 may receive data (i.e., a flow) from a source device (not shown) to be forwarded over LAG 205 to a destination device (not shown) via an egress port 265 of network fabric 240. Based on information exchanged within network fabric 250, the network device associated with ingress port 255 may determine loads associated with usage of the LAG ports and paths in network fabric 250 from the ingress port to the LAG ports (as described above in relation to FIG. 2A).

Subsequent to determining the loads associated with LAG ports 251-254, the network device associated with ingress port 255 can select a first LAG port of LAG ports 251-254 for the flow based on the determined loads, i.e., based on a first load associated with the select first LAG port. For example, the selected port may be LAG port 253, and ingress port 255 may forward the flow over a path 256 (which, as described above, may include other intermediate network devices) to LAG port 253. LAG port 253 can forward the data over a link or path 257 to LAG port 263 of network fabric 260.

Because LAG port 253 is an egress edge port of network fabric 250, the network device associated with LAG port 253 may operate as an egress network device and may determine, based on information such as the depth of its output buffer queue or a rate of change in its output buffer queue, that congestion exists for the flow corresponding to paths 256-257. As a result, the network device may generate and send a congestion ACK (via a communication 266) upstream to ingress port 255. The congestion ACK may include an ECA value which indicates a level of congestion as measured and reported by the network device associated with LAG port 253.

As a result, the network device associated with ingress port 255 can slow down or throttle the flow based on the congestion ACK (received via communication 266). Thus, FIG. 2C depicts throttling a flow based on a congestion ACK received from a local egress LAG port 253 operating as an egress network device and which is selected based on the determined loads of LAG ports 251-254.

The network device associated with a LAG (e.g., LAG 203 in FIG. 2B and LAG 205 in FIG. 2C) may record the state of a flow at egress from the first network fabric (i.e., as traffic enters the LAG). The flow state can be maintained while the flow is present in the second network fabric. As a result, the system can record both the congestion on the LAG itself (as described in relation to the “first” congestion ACK from a local egress LAG port, as in FIG. 2C) and the congestion in the second network fabric (as described above in relation to the “second” congestion ACK from a remote network device in the second network fabric, as in FIG. 2B). The system can compare the ECA values in the first and second congestion ACKs and may return the larger of the two ECA values to the upstream ingress port. Allowing the system to throttle the flow based on the congestion ACK with the greater ECA value may result in a more accurate congestion management technique,

FIG. 2D illustrates an environment 206 which facilitates traffic rerouting in a LAG, including redirect ACKs from LAG ports in a first network fabric 270 which prompt an ingress port in the first network fabric 270 to reroute a flow, in accordance with an aspect of the present application. Network fabrics 270 and 280 may be coupled via a LAG 207, including LAG ports 271-274 on network fabric 270 and LAG ports 281-284 on network fabric 280. An ingress port 275 of network fabric 270 may receive data (i.e., a flow) from a source device (not shown) to be forwarded over LAG 207 to a destination device (not shown) via an egress port 285 of network fabric 280. Based on information exchanged within network fabric 270, the network device associated with ingress port 275 may determine loads associated with usage of the LAG ports and paths in network fabric 270 from the ingress port to the LAG ports (as described above in relation to FIG. 2A).

Subsequent to determining the loads associated with LAG ports 271-274, the network device associated with ingress port 275 can select a first LAG port of LAG ports 271-274 for the flow based on the determined loads, i.e., based on a first load associated with the selected first LAG port. For example, the selected port may be LAG port 273, and ingress port 275 may forward the flow over a path 276 (which, as described above, may include other intermediate network devices) to LAG port 273. LAG port 273 can forward the data over a link or path 277 to LAG port 283 of network fabric 280, and LAG port 283 may forward the data over a path 278 to the destination device (not shown) via egress port 285. The bold lines depicted by paths 276, 277, and 278 indicate the flow from the source to the destination device, including from ingress port 275 in network fabric 270 to egress port 285 in network fabric 280.

During operation, the system, e.g., by a network device associated with LAG port 273, may determine a certain level of congestion associated with LAG port 273. Because the flow extends across two network fabrics, congestion detected by one of LAG ports 271-274 in network fabric 270 may be referred to as “mid-fabric congestion” or “mid-point congestion.” The certain level of this mid-fabric congestion may be based on conditions, e.g.: the information exchanged between the network devices in network fabric 270; whether the load associated with the selected LAG port exceeds a predetermined threshold; whether a total load associated with all the LAG ports in the LAG exceeds a predetermined threshold; whether a change in the loads associated with the LAG ports exceeds a predetermined threshold; and any other conditions or thresholds defined or configured by an administrative user associated with the system. Detecting mid-fabric congestion may also be based on other conditions, such as: the packet size in a respective flow; the length of a respective flow; a number of packets within a respective flow; a pattern of packets based on flow length, packet sizes, and frequency (as in mice and elephant flows); the bandwidth of a respective flow; and the number of concurrent flows all using the LAG at the same time. The conditions described herein are non-limiting and provided for illustrative purposes. Other conditions which trigger the detection of mid-fabric congestion may be possible.

Upon detecting the mid-point or mid-fabric congestion, the network device associated with LAG port 273 may generate and send a redirect ACK (via a communication 286) upstream to ingress port 275. The redirect ACK can indicate that the flow is to be considered as a candidate flow to be rerouted. The network device associated with ingress port 275 may receive the redirect ACK, select the flow (from a plurality of candidate flows to be rerouted), and forward the selected flow on a second path over a second LAG port, e.g., on a path 290 over LAG port 274 of network fabric 270, to LAG port 284 of network fabric 280 over a path or link 291, and on a path 292 to egress port 285 of network fabric 280. The dashed lines depicted by paths 290, 291, and 292 indicate the rerouted flow from the source to the destination device, including from ingress port 275 in network fabric 270 to egress port 285 in network fabric 280. The system can maintain the packet order in the rerouted selected flow while forwarding the selected flow on the second path over the second LAG port. The system can also determine the second path over the second LAG port over which to forward the selected flow based on various factors, e.g.: a load associated with the second LAG port being less than a predetermined threshold (“second predetermined threshold”) (where the redirect ACK can be received based on the first load associated with the first LAG port exceeding the predetermined threshold); a cost of reaching a respective LAG port of the LAG ports; a group associated with the respective LAG port; a type of the selected flow; a QoS associated with the selected flow; and the state of the selected flow. The factors described herein are non-limiting and provided for illustrative purposes. Other factors may be used to determine the second path over which to forward the selected flow.

In some aspects, the network device associated with ingress port 275 may wait a predetermined amount of time (“wait time”) prior to forwarding the flow over the first selected LAG port (as in communication 276 described above) or over the second LAG port (as in communication 290 described above). In an Ethernet network, waiting before rerouting a flow may improve the likelihood of the flow being delivered in order. The network device may wait the predetermined amount of time based on various factors, including a default amount of time or a round trip time associated with sending a packet of the flow to a destination of the flow. In some aspects, the network device may receive a notification to pause the flow, in which case the wait time may be the duration of time for which the flow is paused. The factors described herein for determining the wait time are non-limiting and provided for illustrative purposes. Other factors may be used to determine the wait time. In addition, other methods may be used to determine the wait time.

Thus, FIG. 2D depicts rerouting a flow based on a redirect ACK received from local egress LAG port 273 (operating as a mid-point in a flow extending from first network fabric 270 to second network fabric 280), which is selected based on the determined loads of LAG ports 271-274. The system may reroute flows based on the determined loads of LAG ports 271-274 and other factors, as described above.

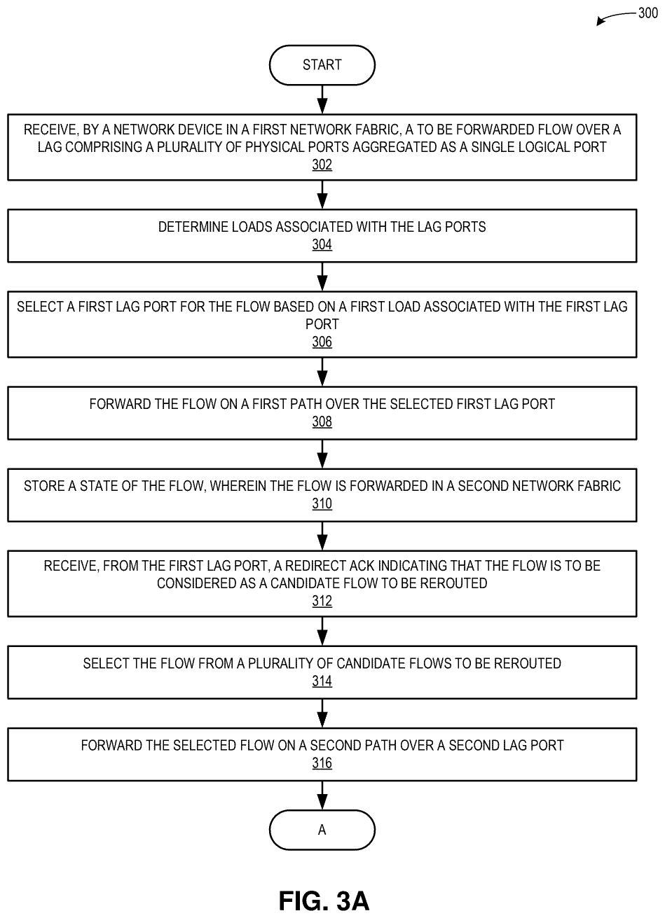

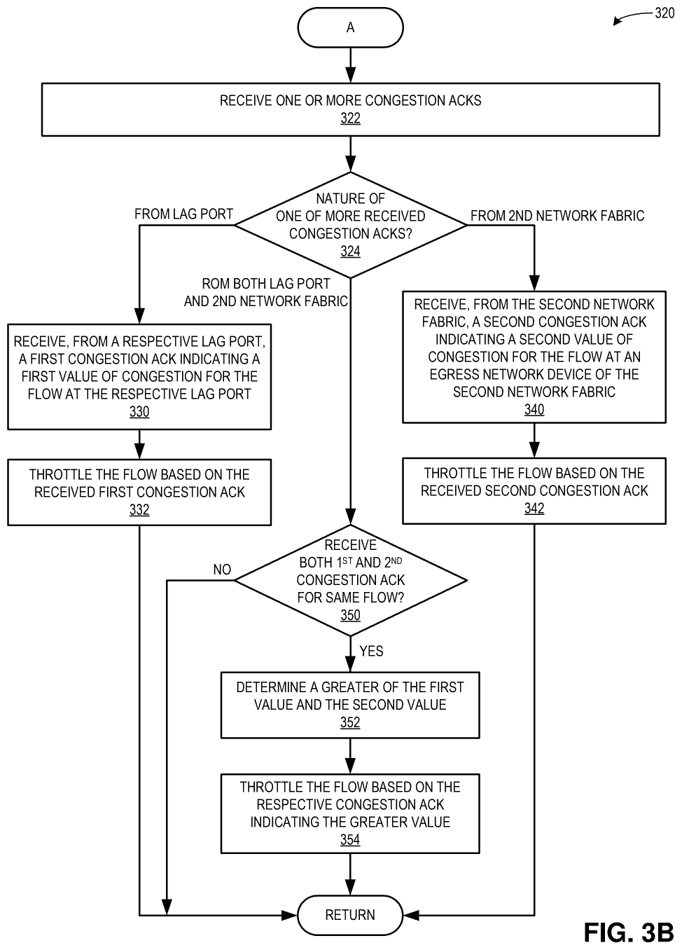

FIG. 3A presents a flowchart 300 illustrating a method which facilitates traffic rerouting in a LAG, in accordance with an aspect of the present application. During operation, the system receives, by a network device in a first network fabric, a to be forwarded flow over a LAG comprising a plurality of physical ports aggregated as a single logical port (operation 302). For example, as described above in relation to FIG. 1A, a data flow may enter a first network fabric 110 from source device 134, and the data flow is to be forwarded over a LAG 156 to destination device 140 over a second network fabric 138. A LAG may include a plurality of physical ports, such as LAG 192 including four physical ports in FIG. 1B or LAG 201 including four physical ports or links in FIG. 2A.

The system determines loads associated with the LAG ports (operation 304). The system can determine these loads based on control information distributed or exchanged between devices in the first network fabric. The amount of the distributed control information can represent a balance or trade-off between precision and bandwidth. One example measure of load can be quantized into four ranges, including “idle,” “lightly loaded,” “moderately loaded,” and “heavily loaded.”

The system selects a first LAG port for the flow based on a first load associated with the first LAG port (operation 306). For example, in FIG. 2A, the network device associated with LAG 201 may select LAG port 213 as the port over which a flow is to be forwarded based on the “lightly loaded” load associated with LAG port 213. The system may also use other factors to select the first LAG port, including, but not limited to, the state or type of the flow, a QoS associated with the flow, a cost of reaching a respective LAG port, etc. In some circumstances (e.g., to prevent flocking), the system may use a mix of the load and a hash or randomization to select the first LAG port. The system can also dynamically adjust the usage of the LAG ports, based on an individual load, cumulative load, or change in loads exceeding a certain corresponding predetermined threshold.

The system forwards the flow on a first path over the selected first LAG port (operation 308). For example, the flow in FIG. 2A may be forwarded over LAG port 213 (depicted by path 217) and the flow in FIG. 2B may be forwarded over LAG port 233 (depicted by path 237).

The system stores a state of the flow, wherein the flow is forwarded in a second network fabric (operation 310). If the first network fabric connects to a switch in a third-party network fabric, the first network fabric can store and use load metrics (and flow state) available in the first network fabric, i.e., as distributed and shared amongst the network devices in the first network fabric. If the first network fabric connects to a switch in a second network fabric which uses the same protocol (e.g., a standard protocol or a proprietary protocol) or interface, the first network fabric can store and use load metrics (and flow state) available in both the first and second network fabrics. In some aspects, even if the second network fabric is a third-party network fabric, the first network fabric may utilize information communicated to it by the second network fabric in order to store and use load metrics for traffic rerouting in a LAG.

The system receives, from the first LAG port, a redirect ACK indicating that the flow is to be considered as a candidate flow to be rerouted (operation 312). For example, in FIG. 2D, the network device associated with LAG port 273 can determine mid-point or mid-fabric congestion at LAG port 273 and can send upstream a redirect ACK (286) indicating that the flow is to be considered as a candidate flow to be rerouted.

The system selects the flow from a plurality of candidate flows to be rerouted (operation 314). The plurality of candidate flows may be flows which are associated with redirect ACKs. Selecting the flow to be rerouted from the plurality of candidate flows may be based on a probability assigned to each flow that a respective flow is to be rerouted.

The system forwards the selected flow on a second path over a second LAG port (operation 316). The system may determine the second path over the second LAG port based on, e.g., a second load associated with the second LAG port (such as being less than a certain threshold), a cost of reaching the second LAG port, a type or state of the selected flow, or a QoS associated with the selected flow. The ingress node may also wait a predetermined amount of time prior to forwarding the flow over the selected first LAG port or the second LAG port (as discussed above in relation to the conservative approach for moving a flow to a different LAG port). The operation continues at Label A of FIG. 3B.

FIG. 3B presents a flowchart 320 illustrating a method which facilitates traffic rerouting in a LAG, including a network device operating as an ingress node, in accordance with an aspect of the present application. The system receives one or more congestion ACKs (operation 322) and determines the nature of the one or more received congestion ACKs (decision 324). The nature of a respective congestion ACK may depend on the source or originator of the respective congestion ACK (e.g., from a LAG port of the first network fabric or from the second network fabric) and the indicated value of congestion for the flow. The system receives at least one of: from a respective LAG port, a first congestion ACK indicating a first value of congestion for the flow at the respective LAG port (operation 330); or from the second network fabric, a second congestion ACK indicating a second value of congestion for the flow at an egress network device of the second network fabric (operation 340). For example, FIG. 2C depicts a first congestion ACK (266) received from a local LAG port (253), while FIG. 2B depicts a second congestion ACK (246-248) received from a second network fabric (240) (e.g., from egress port 245 of network fabric 240). The system can store the state of the flow, e.g., including the ECA value indicated in each congestion ACK.

Subsequent to the system receiving the first congestion ACK (in operation 330), the system throttles the flow based on the first received congestion ACK (operation 332) and the operation returns. For example, in FIG. 2C, the network device associated with ingress port 255 can throttle the flow indicated in received congestion ACK 266.

Subsequent to the system receiving the second congestion ACK (in operation 340), the system throttles the flow based on the second received congestion ACK (operation 342) and the operation returns. For example, in FIG. 2B, the network device associated with ingress port 255 can throttle the flow indicated in received congestion ACK 248 (which is sent as congestion ACK 246 by egress port 245 in network fabric 240).

In some aspects, the system determines if it receives both the first and the second congestion ACKs (decision 350). If it does not, the operation returns. If it does, the system determines a greater of the first value and the second value (operation 352). The first and second values may be stored as part of the state of the flow as a first ECA value and a second ECA value.

The system throttles the flow based on the respective congestion ACK indicating the greater value (operation 354), which can result in the ingress node recognizing or reacting only to the congestion ACK which indicates the more severe congestion (e.g., with the higher ECA value). Thus, the system may throttle the flow based on at least one of: the received first congestion ACK indicating the first value (as in operation 332); the received second congestion ACK indicating the second value (as in operation 342); and the respective congestion ACK (of the first and second congestion ACKs) indicating a greater of the first value and the second value (as in operation 354). The values indicated in the received congestion ACKs may determine the rate at which the system throttles the flow. The operation returns.

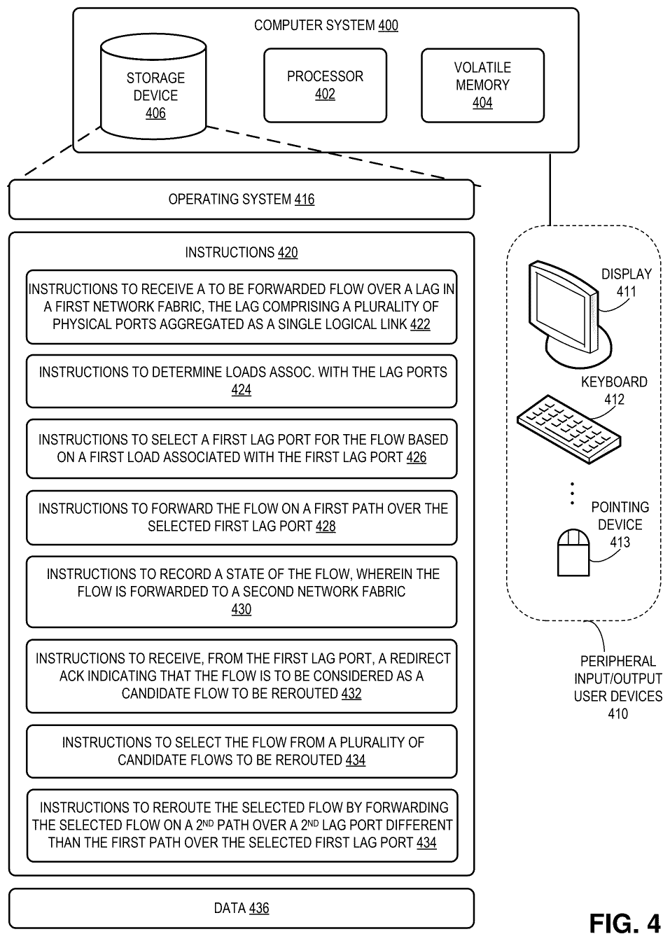

FIG. 4 illustrates a computer system 400 which facilitates traffic rerouting in a LAG, in accordance with an aspect of the present application. Computer system 400 includes a processor 402, a memory 404, and a storage device 406. Memory 404 may include a volatile memory (e.g., random access memory (RAM)) that serves as a managed memory and can be used to store one or more memory pools. Furthermore, computer system 400 may be coupled to peripheral I/O user devices 410 (e.g., a display device 411, a keyboard 412, and a pointing device 413). Storage device 406 includes non-transitory computer-readable storage medium and stores an operating system 416, instructions 420, and data 436. Computer system 400 may include fewer or more entities or instructions than those shown in FIG. 4. Computer system 400 may be a network device with one or more processing resources (e.g., processor 402 or an application-specific integrated circuit (ASIC)) and a storage device (e.g., storage device 406) storing instructions which when executed by the one or more processing resources comprise instructions or cause the network device (e.g., computer system 400) to execute various instructions.

Computer system 400 may include instructions 420, which when executed by processor 402 or computer system 400, can cause computer system 400 to perform methods and/or processes described in this disclosure. Specifically, computer system 400 may store instructions 422 to receive a to be forwarded flow over a LAG in the first network fabric, the LAG comprising a plurality of physical ports aggregated as a single logical port, as described above in relation to LAG 156 of FIG. 1A, LAG 192 of FIG. 1B, and operation 302 of FIG. 3A.

Computer system 400 may store instructions 424 to determine loads associated with the LAG ports, as described above in relation to operation 304 of FIG. 3A. Computer system 400 may store instructions 426 to select a first LAG port for the flow based on a first load associated with the first LAG port, as described above in relation to selecting LAG port 213 of LAG 201 in FIG. 2A and operation 306 of FIG. 3A.

Computer system 400 may store instructions 428 to forward the flow on a first path over the selected first LAG port, as described above in relation to the flow in FIG. 2A being forwarded over LAG port 213, the flow in FIG. 2B being forwarded over LAG port 233, and operation 308 of FIG. 3A.

Computer system 400 may store instructions 430 to record a state of the flow, wherein the flow is forwarded to a second network fabric, as described above in relation to operation 310 of FIG. 3A.

Computer system 400 may store instructions 432 to receive, from the first LAG port, a redirect ACK indicating that the flow is to be considered as a candidate flow to be rerouted, as described above in relation to redirect ACK 286 received from LAG port 273 in FIG. 2D and operation 312 of FIG. 3A.

Computer system 400 may store instructions 434 to select the flow from a plurality of candidate flows to be rerouted, as described above in relation to operation 314 of FIG. 3A. Computer system 400 may store instructions 436 to reroute the selected flow by forwarding the selected flow on a second path over a second LAG port different than the first path over the selected first LAG port, as described above in relation to operation 316 of FIG. 3A.

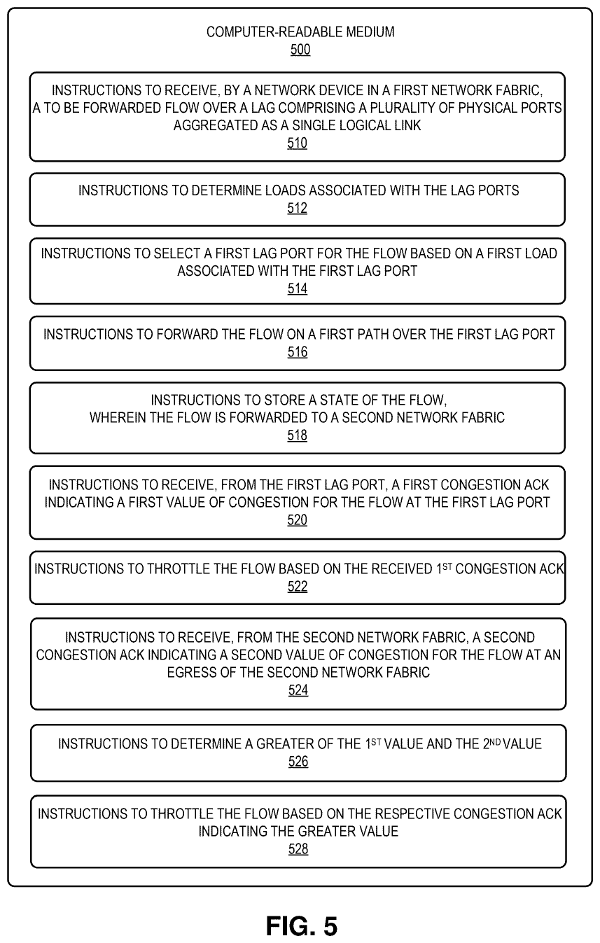

Instructions 420 may include more instructions than those shown in FIG. 4. For example, instructions 420 may include instructions for executing the operations described above in relation to: the environments of FIGS. 1A-B and 2A-D; the operations depicted in the flowcharts of FIGS. 3A-B; and the instructions of CRM 500 in FIG. 5.

Data 436 can include any data that is required as input or that is generated as output by the methods, operations, communications, and/or processes described in this disclosure. Specifically, data 436 can store at least: a load metric; a flow; data of a flow; a value; a redirect ACK; a redirect ACK corresponding to a flow and including a load metric; a plurality of flows; a selected flow; a path; a rerouted path; an indicator or identifier of a LAG, a LAG port, or LAG ports; a load associated with a LAG port; a state of a flow; a candidate flow; information associated with usage of a LAG port or a path in a network fabric to a LAG port; a range; a range of values; a level of usage of a LAG port; a determination of unordered packets or a new flow; a predetermined threshold; a cost of reaching a LAG port; a switch group associated with a LAG port; a type of a flow; a Quality of Service associated with a flow; a result of a hash or a random number generator; a predetermined amount of time; a default amount of time; a round trip time; a notification to pause a flow; a congestion ACK; an ECA value; a comparison of two ECA values; a total load associated with a plurality of LAG ports; a change in load associated with one or more LAG ports; a calculated likelihood of rerouting a flow; the size of packets in a flow; the length of a flow; a number of packets within a flow; a pattern of packets based on flow length, packet sizes, and frequency (as in mice and elephant flows); the bandwidth of a flow; and the number of concurrent flows all using a LAG at the same time.

FIG. 5 illustrates a computer-readable medium (CRM) 500 which facilitates traffic rerouting in a LAG, in accordance with an aspect of the present application. CRM 500 can be a non-transitory computer-readable medium or device storing instructions that when executed by a computer or processor cause the computer or processor to perform a method.

CRM 500 may store instructions 510 to receive, by a network device in a first network fabric, a to be forwarded flow over a LAG comprising a plurality of physical ports aggregated as a single logical port, as described above in relation to LAG 156 of FIG. 1A, LAG 192 of FIG. 1B, and operation 302 of FIG. 3A.

CRM 500 may store instructions 512 to determine loads associated with the LAG ports, as described above in relation to operation 304 of FIG. 3A. CRM 500 may store instructions 514 to select a first LAG port for the flow based on a first load associated with the first LAG port, as described above in relation to selecting LAG port 233 of LAG 203 in FIG. 2B and operation 306 of FIG. 3A.

CRM 500 may store instructions 516 to forward the flow on a first path over the first LAG port, as described above in relation to the flow (e.g., 216, 217) in FIG. 2A being forwarded over LAG port 213, the flow (e.g., 236, 237) in FIG. 2B being forwarded over LAG port 233, and operation 308 of FIG. 3A.

CRM 500 may store instructions 518 to store a state of the flow, wherein the flow is forwarded to a second network fabric, as described above in relation to operation 310 of FIG. 3A.

CRM 500 may store instructions 520 to receive, from the first LAG port, a first congestion ACK indicating a first value of congestion for the flow at the first LAG port, as described above in relation to congestion ACK 266 sent by LAG port 253 of FIG. 2C and operation 330 of FIG. 3B.

CRM 500 may store instructions 522 to throttle the flow based on the received first congestion ACK, as described above in relation to congestion ACK 266 sent by LAG port 253 of FIG. 2C and operation 332 of FIG. 3B.

CRM 500 may store instructions 524 to receive, from the second network fabric, a second congestion ACK indicating a second value of congestion for the flow at an egress of the second network fabric, as described above in relation to congestion ACK 246 sent by egress port 245 of FIG. 2B and operation 340 of FIG. 3B.

CRM 500 may store instructions 526 to determine a greater of the first value and the second value, as described above in relation to operations 350 and 352 of FIG. 3B.

CRM 500 may store instructions 528 to throttle the flow based on the respective congestion ACK indicating the greater value, as described above in relation to operation 354 of FIG. 3B.

CRM 500 may include more instructions than those shown in FIG. 5. For example, CRM 500 may also store instructions for executing the operations described above in relation to: the environments of FIGS. 1A-B and 2A-D; the operations depicted in the flowcharts of FIGS. 3A-B; and instructions 420 of computer system 400 in FIG. 4.

The term “network device” refers to any device, component, or computing entity which can provide a communication pipeline for packets sent from a “processing node” or an “endpoint node.” A processing or endpoint node can refer to a device, component, or hardware component which can operate as a source or a destination of data, including e.g., a control packet or a data packet. A network device may include an ingress network device, an intermediate or mid-point network device, or an egress or endpoint network device. An example of a network device may be a switch, as described above in relation to FIG. 1. A processing node or endpoint node can include an ingress node (which is an endpoint for data returned from a request) or an egress node (which is an endpoint for data sent from a request). Additionally, a network device may operate as or perform the functionality described herein of an ingress network device, an intermediate network device, or an egress network device.

The terms “network,” “network fabric,” and “switch fabric” are used interchangeably in this disclosure and refer to interconnected network devices (such as access points, switches, and routers) that can exchange data and resources with each other. A network fabric can include a mesh of connections between network devices that transport data to its destination. A network fabric may include ingress network devices, intermediate network devices, and egress network devices.

In general, the disclosed aspects provide a method, computing system, and a computer-readable medium which facilitate traffic rerouting in a LAG. The system receives, by a network device in a first network fabric, a to be forwarded flow over a link aggregation group (LAG) comprising a plurality of physical ports aggregated as a single logical port. The system determines loads associated with the LAG ports. The system selects a first LAG port for the flow based on a first load associated with the first LAG port. The system forwards the flow on a first path over the selected first LAG port. The system stores a state of the flow, wherein the flow is forwarded in a second network fabric. The system receives, from the first LAG port, a redirect acknowledgment (ACK) indicating that the flow is to be considered as a candidate flow to be rerouted. The system selects the flow from a plurality of candidate flows to be rerouted. The system forwards the selected flow on a second path over a second LAG port.

In a variation on this aspect, determining the loads associated with the LAG ports comprises receiving, from one or more other network devices in the first network fabric, information associated with usage of: the LAG ports; and paths in the first network fabric from the network device to the LAG ports.

In a further variation on this aspect, a respective load associated with a respective LAG port comprises a value in a plurality of ranges of values, and a respective range indicates a level of usage of the respective LAG port.

In a further variation, the system selects the first LAG port in response to the flow comprising at least one of: unordered packets; or a new flow.

In a further variation, the system selects the first LAG port by identifying a set of LAG ports associated with loads less than a first predetermined threshold and selecting the first LAG port from the identified set of LAG ports based on at least one of: performing a hash on one or more fields of a header of a packet in the flow; or selecting the first LAG port from the identified set of LAG ports based on a random number generator.

In a further variation, the system waits a predetermined amount of time prior to forwarding the flow over the selected first LAG port or the second LAG port. The predetermined amount of time is based on at least one of: a default amount of time; a round trip time associated with sending a packet of the flow to a destination of the flow; or whether a notification to pause the flow is received by the network device in the first network fabric.

In a further variation, the system determines the second path over the second LAG port over which to forward the selected flow based on at least one of: a second load associated with the second LAG port being less than a second predetermined threshold, wherein the redirect ACK is received based on the first load associated with the first LAG port exceeding the second predetermined threshold; a cost of reaching a respective LAG port of the LAG ports; a group associated with the respective LAG port; a type of the selected flow; a Quality of Service associated with the selected flow; or the state of the selected flow.

In a further variation, the system receives at least one of: from a respective LAG port, a first congestion ACK indicating a first value of congestion for the flow at the respective LAG port; or from the second network fabric, a second congestion ACK indicating a second value of congestion for the flow at an egress of the second network fabric. Storing the state comprises storing the first value and the second value.

In a further variation, the system throttles the flow based on at least one of: the received first congestion ACK indicating the first value; the received second congestion ACK indicating the second value; or the respective congestion ACK indicating a greater of the first value and the second value.

In a further variation, the system receives the redirect ACK from the first LAG port in response to at least one of: a respective load associated with the first LAG port exceeding a third predetermined threshold; a total load associated with the LAG ports exceeding a fourth predetermined threshold; or a change in the loads associated with the LAG ports exceeding a fifth predetermined threshold.

In another aspect, a network device operates in a first network fabric and comprises one or more processing resources and a storage device storing instructions which when executed by the one or more processing resources comprise various instructions. The instructions are to receive a to be forwarded flow over a LAG in the first network fabric, the LAG comprising a plurality of physical ports aggregated as a single logical port. The instructions are further to determine loads associated with the LAG ports. The instructions are further to select a first LAG port for the flow based on a first load associated with the first LAG port. The instructions are further to forward the flow on a first path over the selected first LAG port. The instructions are further to record a state of the flow, wherein the flow is forwarded to a second network fabric. The instructions are further to receive, from the first LAG port, a redirect acknowledgment (ACK) indicating that the flow is to be considered as a candidate flow to be rerouted. The instructions are further to select the flow from a plurality of candidate flows to be rerouted. The instructions are further to reroute the selected flow by forwarding the selected flow on a second path over a second LAG port different than the first path over the selected first LAG port. The instructions may include additional instructions, including in relation to: the environments of FIGS. 1A-B and 2A-D; the operations depicted in the flowcharts of FIGS. 3A-B; instructions 420 of computing system 400 in FIG. 4; and the instructions of CRM 500 in FIG. 5.

In a variation on this aspect, a respective load associated with a respective LAG port comprises a value based on at least one of: a first range of values indicating that the respective LAG port is idle; a second range of values indicating that the respective LAG port is lightly loaded; a third range of values indicating that the respective LAG port is moderately loaded; or a fourth range of values indicating that the respective LAG port is heavily loaded. The first range comprises values less than second range, the second range comprises values less than the third range, and the third range comprises values less than the fourth range.

In a further variation on this aspect, the instructions of the computing system are further to receive the redirect ACK in response to at least one load associated with the LAG ports exceeding a corresponding predetermined threshold. The instructions are further to select the flow from the plurality of candidate flows to be rerouted based on a calculated likelihood for rerouting flows.

In a further variation, the first network fabric and the second network fabric comprise at least one of: an Ethernet network; a network comprising entities which communicate using an Ethernet-based protocol; or a network based on Ultra Ethernet Consortium (UEC). The first network fabric and the second network fabric may also be based on other standard network transport protocols or proprietary protocols, e.g., InfiniBand, NVLink, and Ultra Accelerator Link (UALink).

In another aspect, a non-transitory computer-readable storage medium (or CRM) stores instructions to receive, by a network device in a first network fabric, a to be forwarded flow over a LAG comprising a plurality of physical ports aggregated as a single logical port. The instructions are further to determine loads associated with the LAG ports. The instructions are further to select a first LAG port for the flow based on a first load associated with the first LAG port. The instructions are further to forward the flow on a first path over the first LAG port and store a state of the flow, wherein the flow is forwarded in a second network fabric. The instructions are further to receive, from the first LAG port, a first congestion acknowledgement (ACK) indicating a first value of congestion for the flow at the first LAG port. The instructions are further to throttle the flow based on the received first congestion ACK. The instructions are further to receive, from the second network fabric, a second congestion ACK indicating a second value of congestion for the flow at an egress of the second network fabric. The instructions are further to determine a greater of the first value and the second value and throttle the flow based on the respective congestion ACK indicating the greater value. The CRM may also store instructions for executing the operations described above in relation to: the environments of FIGS. 1A-B and 2A-D; the operations depicted in the flowcharts of FIGS. 3A-B; instructions 420 of computer system 400 in FIG. 4; and the instructions of CRM 500 in FIG. 5.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
receiving, by a network device in a first network fabric, a to be forwarded flow over a link aggregation group (LAG) comprising a plurality of physical ports aggregated as a single logical port;
determining loads associated with the LAG ports;
selecting a first LAG port for the flow based on a first load associated with the first LAG port;
forwarding the flow on a first path over the selected first LAG port;
storing a state of the flow, wherein the flow is forwarded in a second network fabric;
receiving, from the first LAG port, a redirect acknowledgment (ACK) indicating that the flow is to be considered as a candidate flow to be rerouted;
selecting the flow from a plurality of candidate flows to be rerouted; and
forwarding the selected flow on a second path over a second LAG port.

2. The method of claim 1, wherein determining the loads associated with the LAG ports comprises:
receiving, from one or more other network devices in the first network fabric, information associated with usage of:
the LAG ports; and
paths in the first network fabric from the network device to the LAG ports.

3. The method of claim 1,
wherein a respective load associated with a respective LAG port comprises a value in a plurality of ranges of values, and
wherein a respective range indicates a level of usage of the respective LAG port.

4. The method of claim 1, further comprising:
selecting the first LAG port in response to the flow comprising at least one of:
unordered packets; or
a new flow.

5. The method of claim 1,
wherein selecting the first LAG port comprises:
identifying a set of LAG ports associated with loads less than a first predetermined threshold; and
selecting the first LAG port from the identified set of LAG ports based on at least one of:
performing a hash on one or more fields of a header of a packet in the flow; or
selecting the first LAG port from the identified set of LAG ports based on a random number generator.

6. The method of claim 1, further comprising:
waiting a predetermined amount of time prior to forwarding the flow over the selected first LAG port or the second LAG port;
wherein the predetermined amount of time is based on at least one of:
a default amount of time;
a round trip time associated with sending a packet of the flow to a destination of the flow; or
whether a notification to pause the flow is received by the network device in the first network fabric.

7. The method of claim 1, further comprising:
determining the second path over the second LAG port over which to forward the selected flow based on at least one of:
a second load associated with the second LAG port being less than a second predetermined threshold, wherein the redirect ACK is received based on the first load associated with the first LAG port exceeding the second predetermined threshold;
a cost of reaching a respective LAG port of the LAG ports;
a group associated with the respective LAG port;
a type of the selected flow;
a Quality of Service associated with the selected flow; or
the state of the selected flow.

8. The method of claim 1, further comprising:
receiving at least one of:
from a respective LAG port, a first congestion ACK indicating a first value of congestion for the flow at the respective LAG port; or
from the second network fabric, a second congestion ACK indicating a second value of congestion for the flow at an egress of the second network fabric,
wherein storing the state comprises storing the first value and the second value.

9. The method of claim 8, further comprising:
throttling the flow based on at least one of:
the received first congestion ACK indicating the first value;
the received second congestion ACK indicating the second value; or
the respective congestion ACK indicating a greater of the first value and the second value.

10. The method of claim 1, further comprising:
receiving the redirect ACK from the first LAG port in response to at least one of:
a respective load associated with the first LAG port exceeding a third predetermined threshold;
a total load associated with the LAG ports exceeding a fourth predetermined threshold; or
a change in the loads associated with the LAG ports exceeding a fifth predetermined threshold.

11. A network device operating in a first network fabric, the network device comprising:
one or more processing resources; and
a storage device storing instructions which when executed by the one or more processing resources comprise instructions to:
receive a to be forwarded flow over a link aggregation group (LAG) in the first network fabric, the LAG comprising a plurality of physical ports aggregated as a single logical port;
determine loads associated with the LAG ports;
select a first LAG port for the flow based on a first load associated with the first LAG port;
forward the flow on a first path over the selected first LAG port;
record a state of the flow, wherein the flow is forwarded to a second network fabric;
receive, from the first LAG port, a redirect acknowledgment (ACK) indicating that the flow is to be considered as a candidate flow to be rerouted;
select the flow from a plurality of candidate flows to be rerouted; and
reroute the selected flow by forwarding the selected flow on a second path over a second LAG port different than the first path over the selected first LAG port.

12. The network device of claim 11, the instructions further to:
determine the loads associated with the LAG ports based on control information received from one or more other network devices in the first network fabric,
wherein the information is associated with usage of:
the LAG ports; and
paths in the first network fabric from the network device to the LAG ports.

13. The network device of claim 11,
wherein a respective load associated with a respective LAG port comprises a value based on at least one of:
a first range of values indicating that the respective LAG port is idle;
a second range of values indicating that the respective LAG port is lightly loaded;
a third range of values indicating that the respective LAG port is moderately loaded; or
a fourth range of values indicating that the respective LAG port is heavily loaded; and
wherein the first range comprises values less than second range, the second range comprises values less than the third range, and the third range comprises values less than the fourth range.

14. The network device of claim 11, wherein the instructions to select the first LAG port comprise instructions to:
identify a set of LAG ports associated with loads less than a first predetermined threshold; and
select the first LAG port from the identified set of LAG ports based on at least one of:
a hash of one or more fields of a header of a packet in the flow; or
a random selection of the first LAG port from the identified set of LAG ports.

15. The network device of claim 11, the instructions further to:
wait a predetermined amount of time prior to forwarding the flow over the selected first LAG port or the second LAG port;
wherein the predetermined amount of time is based on at least one of:
a default amount of time;
a round trip time associated with sending a packet of the flow to a destination of the flow; or
whether a notification to pause the flow is received by the network device in the first network fabric.

16. The network device of claim 11, the instructions further to:
receive, from a respective LAG port, a first congestion ACK indicating a first value of congestion for the flow at the respective LAG port;
receive, from the second network fabric, a second congestion ACK indicating a second value of congestion for the flow at an egress of the second network fabric,
wherein the recorded state comprises the first value and the second value;
determine, based on the recorded state, a larger of the first value and the second value; and
slow down the flow based on the respective congestion ACK indicating the larger value.

17. The network device of claim 11, the instructions further to:
receive the redirect ACK in response to at least one load associated with the LAG ports exceeding a corresponding predetermined threshold; and
select the flow from the plurality of candidate flows to be rerouted based on a calculated likelihood for rerouting the candidate flows.

18. The network device of claim 11, wherein the first network fabric and the second network fabric comprise at least one of:
an Ethernet network;
a network comprising entities which communicate using an Ethernet-based protocol; or
a network based on Ultra Ethernet Consortium (UEC).

19. A non-transitory computer-readable medium storing instructions to:
receive, by a network device in a first network fabric, a to be forwarded flow over a link aggregation group (LAG) comprising a plurality of physical ports aggregated as a single logical port;
determine loads associated with the LAG ports;
select a first LAG port for the flow based on a first load associated with the first LAG port;
forward the flow on a first path over the first LAG port;
store a state of the flow, wherein the flow is forwarded in a second network fabric;
receive, from the first LAG port, a first congestion acknowledgement (ACK) indicating a first value of congestion for the flow at the first LAG port;
throttle the flow based on the received first congestion ACK;
receive, from the second network fabric, a second congestion ACK indicating a second value of congestion for the flow at an egress of the second network fabric;
determine a greater of the first value and the second value; and
throttle the flow based on the respective congestion ACK indicating the greater value.

20. The non-transitory computer-readable medium of claim 19, the instructions further to:
receive, from the first LAG port, a redirect ACK indicating that the flow is to be considered as a candidate flow to be rerouted;
select the flow from a plurality of candidate flows to be rerouted;
forward the selected flow on a second path over a second LAG port different than the original path over the first LAG port; and
maintain an order of packets in the selected flow while forwarding the selected flow on the second path over the second LAG port.
